(19) United States
(12) Patent Application Publication
(10) Pub. No.: US 2026/0010042 A1
(43) Pub. Date: Jan. 8, 2026

(54) LIQUID CRYSTAL DISPLAY DEVICE

(71) Applicant: Sharp Display Technology Corporation, Kameyama City (JP)

(72) Inventors: Shinji SHIMADA, Kameyama City (JP); Shinpei HIGASHIDA, Kameyama City (JP)

(21) Appl. No.: 19/257,739

(22) Filed: Jul. 2, 2025

(30) Foreign Application Priority Data
Jul. 8, 2024 (JP) 2024-109608

(51) Int. Cl. G02F 1/1343; G02F 1/1335; G02F 1/137

(52) U.S. Cl. CPC G02F 1/134372; G02F 1/133512; G02F 1/133514; G02F 1/133531; G02F 1/134336; G02F 1/13706; G02F 1/13712

(57) ABSTRACT

A liquid crystal display device includes a first substrate including gate lines extended in a first direction and source lines extended in a second direction intersecting the first direction, a second substrate, and a liquid crystal layer. The first substrate includes a first electrode, an insulating layer, and a second electrode having a long-shaped opening provided therein. In a plan view, a longitudinal direction of the opening is inclined at an angle θ11 in one direction that is either clockwise or counterclockwise with respect to a direction perpendicular to the first direction. In a plan view, an alignment direction of the liquid crystal molecules located near the first substrate and in a central part of the opening, in a state where no voltage is applied, is inclined at an angle θ12 in a direction opposite to the one direction with respect to the direction perpendicular to the first direction.

### BACKGROUND

### 1. Field

The present disclosure relates to a liquid crystal display device.

### 2. Description of the Related Art

As a technology related to a liquid crystal display device, Japanese Unexamined Patent Application Publication No. 2007-248557 discloses a transverse electric field liquid crystal display device including a first substrate, a second substrate, a liquid crystal layer, a pixel electrode, and a common electrode. The second substrate is placed opposite the first substrate. The liquid crystal layer is provided between the first and second substrates. The pixel electrode and the common electrode are formed on a surface of the first substrate that faces the second substrate and generate therebetween an electric field that is parallel to the first substrate. Shapes of the pixel electrode and the common electrode are set so that as a pixel area between the pixel electrode and the common electrode, a major part in which an electric field direction is orthogonal to an initial alignment direction of liquid crystal molecules and a singular part that is smaller than the major part and in which an electric field direction is not orthogonal are formed.

It is desirable to provide a liquid crystal display device that makes it possible to increase the display contrast.

### SUMMARY

According to an aspect of the disclosure, there is provided a liquid crystal display device having a plurality of picture elements arranged in a matrix. The liquid crystal display device includes a first substrate, a second substrate, and a liquid crystal layer. The first substrate includes a plurality of gate lines extended in a first direction, a plurality of source lines extended in a second direction intersecting the first direction, and a non-linear element placed in correspondence with a point of intersection of each gate line and each source line. The second substrate is placed opposite the first substrate. The liquid crystal layer is sandwiched between the first substrate and the second substrate and contains liquid crystal molecules having positive dielectric constant anisotropy. Each picture element is defined by two gate lines that are adjacent to each other and two source lines that are adjacent to each other. The first substrate further includes, in sequence, a first electrode, an insulating layer, and a second electrode having a long-shaped opening provided therein. In a plan view, a longitudinal direction of the opening is inclined at an angle θ11 [degrees] in one direction that is either clockwise or counterclockwise with respect to a direction perpendicular to the first direction. In a plan view, an alignment direction of the liquid crystal molecules located near the first substrate and in a central part of the opening, in a state where no voltage is applied, is inclined at an angle θ12 [degrees] in a direction opposite to the one direction with respect to the direction perpendicular to the first direction.

According to an aspect of the disclosure, there is provided a liquid crystal display device having a plurality of picture elements arranged in a matrix. The liquid crystal display device includes a first substrate, a second substrate, and a liquid crystal layer. The first substrate includes a plurality of gate lines extended in a first direction, a plurality of source lines extended in a second direction intersecting the first direction, and a non-linear element placed in correspondence with a point of intersection of each gate line and each source line. The second substrate is placed opposite the first substrate. The liquid crystal layer is sandwiched between the first substrate and the second substrate and contains liquid crystal molecules having negative dielectric constant anisotropy. Each picture element is defined by two gate lines that are adjacent to each other and two source lines that are adjacent to each other. The first substrate further includes, in sequence, a first electrode, an insulating layer, and a second electrode having a long-shaped opening provided therein. In a plan view, a longitudinal direction of the opening is inclined at an angle θ21 [degrees] in one direction that is either clockwise or counterclockwise with respect to the first direction. In a plan view, an alignment direction of the liquid crystal molecules located near the first substrate and in a central part of the opening, in a state where no voltage is applied, is inclined at an angle θ22 [degrees] in a direction opposite to the one direction with respect to the first direction.

### BRIEF DESCRIPTION OF THE DRAWINGS

FIG. 1 is a plan schematic view of a liquid crystal display device according to Embodiment 1;

FIG. 2 is a cross-sectional schematic view of the liquid crystal display device according to Embodiment 1 as taken along line II-II in FIG. 1;

FIG. 3 is a plan schematic view of an FFS mode liquid crystal display device of a comparative example;

FIG. 4 is a plan schematic view of a liquid crystal display device according to Embodiment 2; and

FIG. 5 is a plan schematic view of a liquid crystal display device according to a modification of Embodiments 1 and 2.

### DESCRIPTION OF THE EMBODIMENTS

The following describes embodiments of the present disclosure. The present disclosure is not limited in content to the following description of the embodiments but can be appropriately designed and changed within such a range as to fulfill a configuration of the present disclosure. In the following description, identical components or components having similar functions are appropriately given identical reference signs that are adhered to throughout different drawings, and a repeated description of such components is appropriately omitted. Aspects of the present disclosure may be appropriately combined with one another without departing from the scope of the present disclosure.

### Embodiment 1

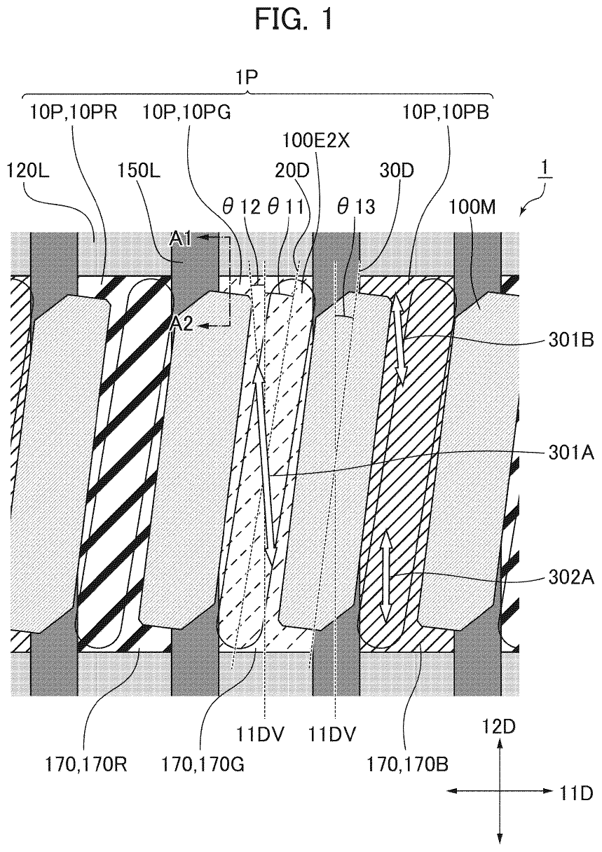

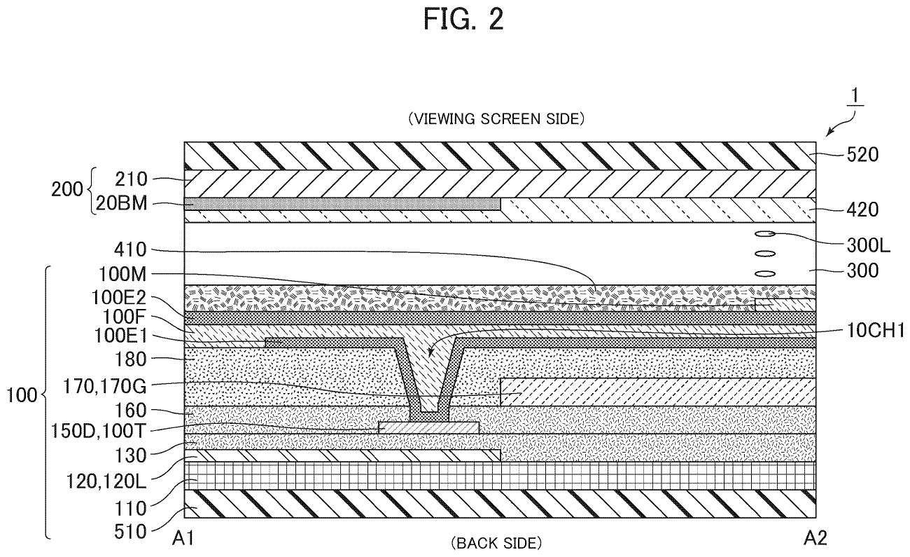

FIG. 1 is a plan schematic view of a liquid crystal display device according to Embodiment 1. FIG. 2 is a cross-sectional schematic view of the liquid crystal display device according to Embodiment 1 as taken along line II-II in FIG. 1.

As shown in FIGS. 1 and 2, a liquid crystal display device 1 according to the present embodiment has a plurality of picture elements 10P arranged in a matrix. The liquid crystal display device 1 includes a first substrate 100, a second substrate 200, and a liquid crystal layer 300. The first substrate 100 includes a plurality of gate lines 120L extended in a first direction 11D, a plurality of source lines 150L extended in a second direction 12D intersecting the first direction 11D, and a non-linear element 100T placed in correspondence with a point of intersection of each gate line 120L and each source line 150L. The second substrate 200 is placed opposite the first substrate 100. The liquid crystal layer 300 is sandwiched between the first substrate 100 and the second substrate 200 and contains liquid crystal molecules 300L having positive dielectric constant anisotropy. Each picture element 10P is defined by two gate lines 120L that are adjacent to each other and two source lines 150L that are adjacent to each other. The first substrate 100 further includes, in sequence, a first electrode 100E1, an insulating layer 100F, and a second electrode 100E2 having a long-shaped opening 100E2X provided therein. In a plan view, a longitudinal direction 20D of the opening 100E2X is inclined at an angle θ11 [degrees] in one direction that is either clockwise or counterclockwise (in the present embodiment, clockwise) with respect to a direction 11DV perpendicular to the first direction 11D, and in a plan view, an alignment direction 301A of the liquid crystal molecules 300L located near the first substrate 100 and in a central part of the opening 100E2X, in a state where no voltage is applied, is inclined at an angle θ12 [degrees] in a direction (in the present embodiment, counterclockwise) opposite to the one direction with respect to the direction 11DV perpendicular to the first direction 11D. Such an aspect makes it possible to improve the display contrast.

Further, the direction perpendicular to the first direction refers to a direction that forms an angle of 90 degrees with respect to the first direction. The first direction 11D and the direction 11DV perpendicular to the first direction 11D form an angle of 90 degrees.

Further, unless otherwise noted, that two straight lines (including polarizing axes and directions) are orthogonal to each other herein means that they form an angle of 87 degrees or larger and 90 degrees or smaller, preferably 89 degrees or larger and 90 degrees or smaller, more preferably 89.5 degrees or larger and 90 degrees or smaller, especially preferably 90 degrees (completely orthogonal). Further, that two straight lines (including polarizing axes and directions) are parallel to each other herein means that they form an angle (absolute value) of 0 degree or larger and 3 degrees or smaller, preferably 0 degree or larger and 1 degree or smaller, more preferably 0 degree or larger and 0.5 degree or smaller, especially preferably 0 degree (completely parallel).

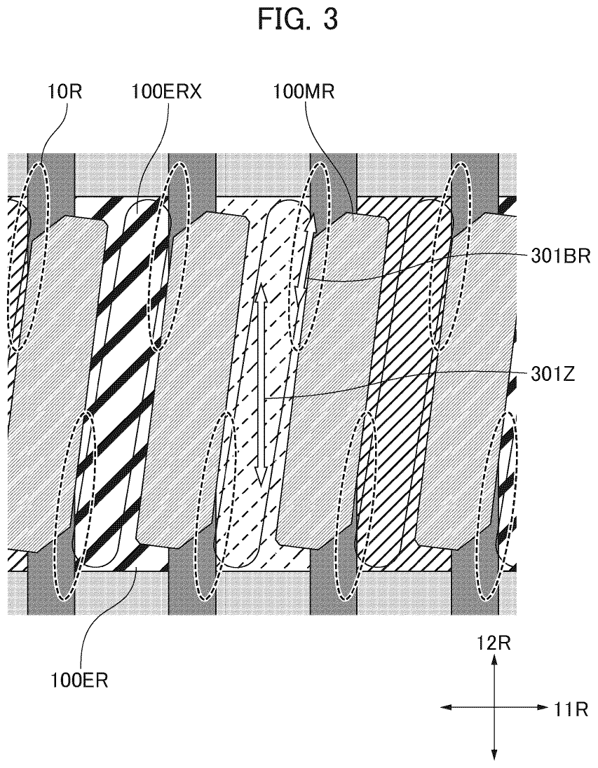

FIG. 3 is a plan schematic view of an FFS mode liquid crystal display device of a comparative example. It is usual for a liquid crystal display device for use in a head-mounted display to use an FFS (fringe field switching) mode shown in FIG. 3 as a display mode in order to suppress a color shift within a viewing angle. In view of a configuration that is easy to optimally design optically, a slit (opening 100ERX) inclined at approximately 5 degrees to 15 degrees with respect to a horizontal direction 11R or a vertical direction 12R of a panel outer shape as shown in FIG. 3 needs to be placed in an electrode 100ER in the FFS mode. Accordingly, a pattern of wires and a light-shielding film 100MR needs to be placed at an angle.

In a panel with a resolution near 1200 ppi or higher, a step of a pattern on a substrate undesirably causes an alignment direction 301BR in the absence of the application of a voltage of liquid crystal molecules near the step to deviate by 2 degrees to 6 degrees from an originally assumed alignment direction 301Z (in FIG. 3, the vertical direction 12R of the panel outer shape) and results in increased black luminance that may lead to a decrease in display contrast. An area 10R surrounded by a dashed line in FIG. 3 is an area where the alignment direction of liquid crystal molecules in the absence of the application of a voltage greatly deviates from the originally assumed alignment direction 301Z. Unless otherwise noted, the alignment direction of liquid crystal molecules herein means the alignment direction of liquid crystal molecules in the absence of the application of a voltage.

The following represents a possible cause of this. It is conceivable that a step obliquely inclined with respect to the original alignment direction 301Z of liquid crystal molecules in the absence of the application of a voltage (i.e. a step whose edge extends in a direction having a predetermined inclination with respect to the alignment direction 301Z) may cause the alignment direction 301BR of liquid crystal molecules near the step to be distorted and result in increased black luminance in an area of several micrometers near the step. In particular, in a panel with a resolution near 1200 ppi or higher, it is conceivable that there may be a remarkably decrease in display contrast, as the picture elements have widths of only several micrometers.

In the present embodiment, by performing an alignment process on a first alignment film 410 so that with reference to the original alignment direction of the liquid crystal molecules 300L in the absence of the application of a voltage (i.e. the vertical direction of the panel outer shape, that is, the direction 11DV perpendicular to the first direction 11D, in which the gate lines 120L are extended), the alignment direction 301A in the absence of the application of a voltage of those of the liquid crystal molecules 300L located near the first substrate 100 and in a central part of the opening 100E2X has a given angle in a direction opposite to the direction of inclination of the pattern on the substrate (specifically, the longitudinal direction 20D of the opening 100E2X of the second electrode 100E2), the black luminance of the picture elements 10P as a whole can be reduced, so that the display contrast can be improved. In particular, in a case where the resolution of the liquid crystal display device 1 is 1200 ppi or higher, the display contrast can be effectively improved.

Meanwhile, Japanese Unexamined Patent Application Publication No. 2007-248557 attempts to improve transmittance by removing diagonal wiring from many areas of pixels in an IPS (in-plane switching) mode liquid crystal display device. However, it is very difficult to achieve, in a high-definition liquid crystal display device for use in a head-mounted display, an electrode structure disclosed in Japanese Unexamined Patent Application Publication No. 2007-248557. Further, even if such an electrode structure can be achieved, the alignment of liquid crystal molecules becomes unstable in an area where pixel electrodes are not angled (i.e. an area where the outer edges of pixel electrodes are parallel to the vertical direction or horizontal direction of the panel outer shape), so that there may be a decrease in operating speed. Accordingly, with Japanese Unexamined Patent Application Publication No. 2007-248557, it is difficult to improve the display contrast. Japanese Unexamined Patent Application Publication No. 2007-248557, which pays attention to an electrode structure, fails to disclose the configuration of the present disclosure, which pays attention to the initial alignment direction of liquid crystal molecules. The following describes the liquid crystal display device 1 of the present embodiment in detail.

As shown in FIG. 2, the liquid crystal display device 1 of the present embodiment includes a first substrate 100, a liquid crystal layer 300, and a second substrate 200. Although, in the present embodiment, the first substrate 100 is placed at a back side and the second substrate 200 is placed at a viewing screen side, the first substrate 100 may be placed at the viewing screen side and the second substrate 200 may be placed at the back side.

The liquid crystal display device 1 may include a first alignment film 410 between the first substrate 100 and the liquid crystal layer 300. Similarly, the liquid crystal display device 1 may include a second alignment film 420 between the second substrate 200 and the liquid crystal layer 300.

The liquid crystal display device 1 may include a first polarizing plate 510, placed on a side of the first substrate 100 that faces away from the liquid crystal layer 300, that has a first polarizing axis parallel or orthogonal to the first direction 11D and a second polarizing plate 520, placed on a side of the second substrate 200 that faces away from the liquid crystal layer 300, that has a second polarizing axis orthogonal to the first polarizing axis.

The liquid crystal display device 1 may further include a backlight at a side of the first polarizing plate 510 that faces away from the liquid crystal layer 300.

The liquid crystal display device 1 includes an active area (image display area) where an image is displayed, and the active area is composed of a plurality of picture elements 10P arrayed in a matrix in a horizontal direction of a screen (in the present embodiment, the first direction 11D) and a vertical direction of the screen (in the present embodiment, the second direction 12D).

The first substrate 100 includes a first support substrate 110, a plurality of gate lines 120L extended parallel to each other in the first direction 11D on a side of the first support substrate 110 that faces the liquid crystal layer 300, a first insulating layer 130 placed on a side of the plurality of gate lines 120L that faces the liquid crystal layer 300, and a plurality of source lines 150L extended parallel to each other in the second direction 12D on a side of the first insulating layer 130 that faces the liquid crystal layer 300. The plurality of gate lines 120L and the plurality of source lines 150L are formed in a grid pattern as a whole so as to demarcate each picture element 10P. A non-linear element 100T is placed at a point of intersection of each gate line 120L and each source line 150L. In the present embodiment, the first direction 11D is orthogonal to the second direction 12D. Although, in the present embodiment, the first direction 11D corresponds to a row direction of picture elements 10P arranged in a matrix (hereinafter sometimes simply referred to as “row direction”) and the second direction 12D corresponds to a column direction of picture elements 10P arranged in a matrix (hereinafter sometimes simply referred to as “column direction”), the first direction 11D may correspond to the column direction of picture elements 10P and the second direction 12D may correspond to the row direction of picture elements 10P.

Each non-linear element 100T is a three-terminal switch connected to a corresponding one of the plurality of gate lines 120L and a corresponding one of the plurality of source lines 150L. The non-linear element 100T has a gate electrode protruding from the corresponding gate line 120L (being a part of the corresponding gate line 120L), a source electrode protruding from the corresponding source line 150L (being a part of the corresponding source line 150L), a drain electrode 150D connected to a corresponding one of a plurality of pixel electrodes (in the present embodiment, first electrodes 100E1), and a semiconductor layer 140. The source electrode and the drain electrode 150D are electrodes provided at the same source wiring layer 150 as the source line 150L, and the gate electrode is an electrode provided at the same gate wiring layer 120 as the gate line 120L.

The first substrate 100 includes the first support substrate 110, the gate wiring layer 120, at which the gate line 120L is provided, the first insulating layer 130, the semiconductor layer 140, the source wiring layer 150, at which the source line 150L is provided, a second insulating layer 160, a color filter (CF) layer 170, a planarizing film 180, a first electrode 100E1, an insulating layer 100F, a second electrode 100E2 having an opening 100E2X provided therein, and a light-shielding film 100M in this order toward the liquid crystal layer 300.

The first substrate 100 includes, in sequence, a first electrode 100E1, an insulating layer 100F, and a second electrode 100E2 having a long-shaped opening 100E2X provided therein. Such an aspect makes it possible to achieve the FFS mode as a display mode.

In a plan view, a longitudinal direction 20D of the opening 100E2X is inclined at an angle θ11 [degrees] in one direction that is either clockwise or counterclockwise (in the present embodiment, clockwise) with respect to a direction 11DV perpendicular to the first direction 11D. Further, in a plan view, an alignment direction 301A in the absence of the application of a voltage of those of the liquid crystal molecules 300L located near the first substrate 100 and in a central part of the opening 100E2X is inclined at an angle θ12 [degrees] in a direction (in the present embodiment, counterclockwise) opposite to the one direction with respect to the direction 11DV perpendicular to the first direction 11D.

The central part of the opening is an area of overlap between a central part (i.e. an area extending over a certain range) of the opening in the longitudinal direction and a central part (i.e. an area extending over a certain range) of the opening in a width direction (i.e. a direction forming an angle of 90 degrees with respect to the longitudinal direction). The central part of the opening in the longitudinal direction is, for example, an area located in the middle one of three areas obtained by dividing the opening into three equal parts in the longitudinal direction. The central part of the opening in the width direction is, for example, an area located in the middle one of three areas obtained by dividing the opening into three equal parts in the width direction.

The alignment direction of liquid crystal molecules in the absence of the application of a voltage can be specified in the following manner. Since an alignment film (e.g. a commonly used heat-resistant polymer alignment film) has a phase difference in the alignment direction of liquid crystal molecules, the alignment direction of liquid crystal molecules in the absence of the application of a voltage can be the direction of the phase difference of the alignment film as measured by a polarization microscopic measurement device (e.g. polarization microspectrophotometer (manufactured by ORC MANUFACTURING CO., LTD. as TFM-120AFT-PC)). In a case where the phase difference of the alignment film is so minute that it is difficult to specify the direction of the phase difference of the alignment film, the alignment direction of liquid crystal molecules in the absence of the application of a voltage can be a direction of minimum transmittance of polarized light that falls on a layered product including the alignment film, a liquid crystal layer containing liquid crystal molecules, and a polarizing plate in this order and that has a polarization axis forming an angle of 90 degrees with respect to a transmission axis of the polarizing plate from the direction of the alignment film.

The liquid crystal display device 1 may satisfy Formula 1-1 as below. Such an aspect makes it possible to further improve the display contrast.

θ12<θ11 (Formula 1-1)

It is preferable that the angle θ12 [degrees] be 0.01 or more times and 0.5 or less times as large as the angle θ11 [degrees], more preferably 0.01 or more times and 0.2 or less times as large as the angle θ11 [degrees], even more preferably 0.05 or more times and 0.2 or less times as large as the angle θ11 [degrees].

The liquid crystal display device 1 may satisfy Formula 1-2 as below. Such an aspect makes it possible to further improve the display contrast.

0°<θ11<45° (Formula 1-2)

It is preferable that the angle θ11 [degrees] be 2 degrees or larger and 45 degrees or smaller, more preferably 5 degrees or larger and 15 degrees or smaller. Such an aspect makes it possible to achieve a high-definition and high-drive-frequency liquid crystal display device 1.

It is preferable that the angle θ12 [degrees] be 0.2 degree or larger and 5 degrees or smaller, more preferably 0.5 degree or larger and 3 degrees or smaller, even more preferably 0.5 degree or larger and 2 degrees or smaller.

In a plan view, an alignment direction 302A in the absence of the application of a voltage of those of the liquid crystal molecules 300L located near the second substrate 200 and in the central part of the opening 100E2X may be orthogonal to the first direction 11D. Such an aspect makes it possible to further improve the display contrast. That the alignment direction is orthogonal to the first direction here means that the alignment direction and the first direction form an angle of 89.5 degrees or larger and 90 degrees or smaller.

The various types of wire and electrode that constitute the gate line 120L, the source line 150L, and the non-linear element 100T can be formed by forming a film of a metal such as copper, titanium, aluminum, molybdenum, or tungsten or an alloy thereof in a single layer or multiple layers by sputtering or other methods and then patterning the film by photolithography or other methods. Those of the various types of wire and electrode which are formed at the same layer are efficiently manufactured by using the same material.

The first insulating layer 130 is a gate insulating layer. The first insulating layer 130 is, for example, an inorganic insulating layer. Usable examples of the inorganic insulating layer include an inorganic film (relative dielectric constant ε=5 to 7) of, for example, silicon nitride (SiNₓ) or silicon oxide (SiO₂) and a laminated film thereof.

The semiconductor layer 140 is constituted, for example, by a high-resistance semiconductor layer composed of, for example, amorphous silicon or polysilicon and a low-resistance semiconductor layer composed of, for example, n+ amorphous silicon obtained by doping amorphous silicon with an impurity such as phosphorus. Alternatively, the semiconductor layer 140 may be an oxide semiconductor layer of, for example, indium gallium zinc oxide (IGZO).

The second insulating layer 160 is, for example, an inorganic insulating layer. Usable examples of the inorganic insulating layer include an inorganic film (relative dielectric constant ε=5 to 7) of, for example, silicon nitride (SiNₓ) or silicon oxide (SiO₂) and a laminated film thereof.

The color filter layer 170 is placed on a side of the second insulating layer 160 that faces the liquid crystal layer 300. The color filter layer 170 is composed of red color filters 170R, blue color filters 170B, and green color filters 170G.

The plurality of picture elements 10P include red picture elements 10PR including the red color filters 170R, blue picture elements 10PB including the blue color filters 170B, and green picture elements 10PG including the green color filters 170G. One pixel 1P is constituted by three picture elements 10P, namely a red picture element 10PR, a blue picture element 10PB, and a green picture element 10PG. In one pixel 1P, these three picture elements 10P are arranged in stripes.

The first substrate 100 includes the color filter layer 170. Thus, adopting a COA (CF on Array) structure in which the color filter layer 170 is placed in the first substrate 100 allows light from the back side of the liquid crystal display device 1 to pass through the color filter layer 170 before passing through the liquid crystal layer 300. Accordingly, even in a case where a glowing picture element is observed in an oblique direction, light having traveled through the color filter of the glowing picture element is observed through the liquid crystal layer 300, so that a mixture of colors in an oblique view can be suppressed. Further, using the COA technology makes it unnecessary to increase the width of a black matrix layer in order to suppress a mixture of colors in an oblique view, thus making it unnecessary to reduce the transmittance (aperture ratio). This makes it possible to suppress a mixture of colors in an oblique view while suppressing a reduction in transmittance.

It is preferable that the color filter layer 170 be a micro color filter layer. The micro color filter layer is a minute color filter layer.

Although, in the present embodiment, the first substrate 100 includes the color filter layer 170, not the first substrate 100 but the second substrate 200 may include the color filter layer 170.

The planarizing film 180 is an insulating film that absorbs asperities on a surface (foundation) on which the film is formed and that planarizes a substrate surface on which the film has been formed. The planarizing film 180 allow the liquid crystal display device 1 to remain the same in cell thickness. As the planarizing film 180, an organic insulating film is suitable. A usable example of the organic insulating film is an organic film of, for example, acrylic resin, polyimide resin, or novolak resin. A suitably usable example of the organic insulating film is an organic film of, for example, photosensitive acrylic resin with a low relative dielectric constant (relative dielectric constant ε=2 to 5).

One of the first electrode 100E1 and the second electrode 100E2 is a pixel electrode, and the other is a common electrode. In the present embodiment, the first electrode 100E1 is a pixel electrode, and the second electrode 100E2 is a common electrode. Such an aspect make it hard for positional and electrical interference to occur between a through-hole 10CH1 through which the drain electrode 150D and the pixel electrode are connected to each other and the light-shielding film 100M, making easy design possible. In a case where the light-shielding film 100M contains an electric conductor such as a metal, this effect is further increased.

The pixel electrode is an electrode placed in each area surrounded by two gate lines 120L that are adjacent to each other and two source lines 150L that are adjacent to each other. The pixel electrode is placed in each picture element 10P. The pixel electrode is connected to the corresponding non-linear element 100T and connected to the corresponding source line 150L via the semiconductor layer 140 of the non-linear element 100T. The pixel electrode is set to a potential corresponding to a data signal that is supplied via the corresponding non-linear element 100T.

The common electrode is an electrode formed substantially all over the picture elements 10P regardless of the boundaries between the picture elements 10P. The common electrode is supplied with a common signal kept at a certain value, so that the common electrode is kept at a certain potential.

The second electrode 100E2 has the long-shaped opening 100E2X provided therein. The second electrode 100E2 has a plurality of the openings 100E2X provided therein. The plurality of openings 100E2X are placed one by one in each picture element 10P.

It is preferable that the second electrode 100E2 be placed closer to the liquid crystal layer 300 than is the first electrode 100E1. The opening 100E2X of the (upper-layer) second electrode 100E2 placed closer to the liquid crystal layer 300 is placed over the lower-layer first electrode 100E1. Although, in the present embodiment, the lower-layer first electrode 100E1 is placed in an area corresponding to at least the opening 100E2X, there may be an area where the first electrode 100E1 is not present in the area corresponding to the opening 100E2X. For example, in a case where the lower-layer first electrode 100E1 is a common electrode, the first electrode 100E1 may be a solid electrode having an opening provided in an area corresponding to a through-hole connecting the upper-layer second electrode 100E2, which is a pixel electrode, with the drain electrode of the non-linear element 100T. Since an electric field that is applied to liquid crystal molecules is determined by a potential difference between the opening 100E2X of the upper-layer second electrode 100E2 and the lower-layer first electrode 100E1, either the upper-layer electrode (second electrode 100E2) or the lower-layer electrode (first electrode 100E1) may be a pixel electrode or a common electrode in terms of how the liquid crystal molecules behave. In a case where the upper-layer electrode is a pixel electrode, the upper-layer electrode has a configuration in which one opening 100E2X is provided in each quadrangular pixel electrode, as the pixel electrode needs to be electrically insulated from an adjacent pixel electrode. Meanwhile, in a case where the upper-layer electrode is a common electrode, the upper-layer electrode has a configuration in which one opening (i.e. as many openings as picture elements in the common electrode as a whole) is provided in an area corresponding to each picture element of a solid electrode spread over the entire area of the screen.

It is preferable that the second electrode 100E2 be placed closer to the liquid crystal layer 300 than is the first electrode 100E1, that the first electrode 100E1 be a pixel electrode, and that the second electrode 100E2 be a common electrode. Such an aspect makes it possible to make a step attributed to an electrode smaller and easily form a through-hole between the pixel electrode and the drain electrode. Alternatively, the second electrode 100E2 may be placed closer to the liquid crystal layer 300 than is the first electrode 100E1, the first electrode 100E1 may be a common electrode, and the second electrode 100E2 may be a pixel electrode. Such an aspect makes it possible to decrease a parasitic capacitance [Cgd} of the non-linear element 100T.

The second electrode 100E2 has a thickness of, for example, 50 nm or greater and 150 nm or less. While it is conceivable that, as shown in FIG. 3, a step of the opening 100ERX provided in the electrode 100ER may cause the alignment direction 301BR in the absence of the application of a voltage of liquid crystal molecules near the step to deviate from the originally assumed alignment direction 301Z and cause a decrease in display contrast, the configuration of the present embodiment makes it possible to improve the display contrast even in a case where the second electrode 100E2 has a thickness of 50 nm or greater and 150 nm or less.

The first electrode 100E1 and the second electrode 100E2 can be formed, for example, by forming a film of a transparent conductive material such as indium tin oxide (ITO), indium zinc oxide (IZO), zinc oxide (ZnO), or tin oxide (SnO) or an alloy thereof in a single layer or multiple layers by sputtering or other methods and then patterning the film by photolithography or other methods.

The insulating layer 100F is an interlayer insulating film and has a function of insulating the first electrode 100E1 and the second electrode 100E2 from each other. As the insulating layer 100F, an inorganic insulating film can be used. Usable examples of the inorganic insulating film include an inorganic film (relative dielectric constant ε=5 to 7) of, for example, silicon nitride (SiNₓ) or silicon oxide (SiO₂) and a laminated film thereof.

The light-shielding film 100M is placed between the plurality of picture elements 10P in a plan view. It is preferable that the light-shielding film 100M be placed between two picture elements 10P that are adjacent to each other in the row direction (in the present embodiment, the first direction 11D). Such an aspect makes it possible to suppress a color deviation during monochromatic display due to leakage of light from an adjacent picture element 10P primarily at an oblique viewing angle.

The light-shielding film 100M contains a metal. It is preferable that the metal contained in the light-shielding film 100M be a metal, such as molybdenum or titanium, whose reflectivity is comparatively low. The light-shielding film 100M may contain a non-metal substance. The light-shielding film 100M includes, for example, a metal film and an insulating layer. Specifically, the light-shielding film 100M may be a layered product in which an insulating film of, for example, silicon oxide or silicon nitride is sandwiched between a plurality of metal films. In a case where the light-shielding film 100M is such a layered product, it is preferable that the metal films included in the layered product be semi-transmissive metal thin-film layers. Such an aspect makes it possible to reduce the reflectivity of the light-shielding film 100M by utilizing interference of light.

The light-shielding film 100M may be placed in an island shape in a plan view.

It is preferable that the light-shielding film 100M be in a long shape. When, in a plan view, a longitudinal direction 30D of the light-shielding film 100M is inclined at an angle θ13 [degrees] in the one direction (in the present embodiment, clockwise) with respect to the direction 11DV perpendicular to the first direction 11D, it is preferable that the liquid crystal display device 1 satisfy Formula (1-3) as below. Such an aspect makes it possible to avoid interference between the light-shielding film 100M and the opening 100E2X of the second electrode 100E2, making it possible to improve display performance.

θ13≤θ11 (Formula 1-3)

The light-shielding film 100M has a thickness of, for example, 40 nm or greater and 200 nm or less. While it is conceivable that, as shown in FIG. 3, a step of the light-shielding film 100MR may cause the alignment direction 301BR in the absence of the application of a voltage of liquid crystal molecules near the step to deviate from the originally assumed alignment direction 301Z and cause a decrease in display contrast, the configuration of the present embodiment makes it possible to improve the display contrast even in a case where the light-shielding film 100M has a thickness of 40 nm or greater and 200 nm or less.

It is preferable that the angle θ13 [degrees] be 0 or more times and 1 or less times as large as the angle θ11 [degrees], more preferably 0 or more times and 0.85 or less times as large as the angle θ11 [degrees], even more preferably 0 or more times and 0.7 or less times as large as the angle θ11 [degrees].

It is preferable that the angle θ12 [degrees] be 0.01 or more times and 0.5 or less times as large as the angle θ11 [degrees], more preferably 0.01 or more times and 0.2 or less times as large as the angle θ11 [degrees], even more preferably 0.05 or more times and 0.2 or less times as large as the angle θ11 [degrees].

It is preferable that the angle θ13 [degrees] be 0 degree or larger and 15 degrees or smaller, more preferably 0 degree or larger and 12.75 degrees or smaller, even more preferably 0 degree or larger and 10.5 degrees or smaller.

The second substrate 200 includes a second support substrate 210.

The second substrate 200 may have a second substrate side light-shielding film 20BM on a side of the second support substrate 210 that faces the liquid crystal layer 300. The second substrate side light-shielding film 20BM may be provided in a grid pattern so as to demarcate each color filter.

The second substrate side light-shielding film 20BM is, for example, a black matrix layer. The black matrix layer is made of any material that has a light blocking effect; however, as the material, a resin material containing a black pigment or a metal material having a light blocking effect is suitably used. The black matrix layer is formed, for example, by applying photosensitive resin containing a black pigment to form a film and subjecting the film to photolithography, which includes performing exposure, development, or other processes.

It is preferable that the second substrate side light-shielding film 20BM be extended along the row direction (in the present embodiment, the first direction 11D) between two picture elements 10P that are adjacent to each other in the column direction (in the present embodiment, the second direction 12D) and not be placed between two picture elements 10P that are adjacent to each other in the row direction (not be extended along the column direction between two picture elements 10P that are adjacent to each other in the row direction). Such an aspect makes it possible to better suppress delamination of the second substrate side light-shielding film 20BM than in a case where the second substrate side light-shielding film 20BM is extended both between two picture elements 10P that are adjacent to each other in the column direction and two picture elements 10P that are adjacent to each other in the row direction. Further, such an aspect makes it possible to, from the point of view of the positioning accuracy with which the first substrate 100 and the second substrate 200 are bonded together, make the aperture ratio higher than in a case where the second substrate side light-shielding film 20BM is extended in the column direction. The second substrate side light-shielding film 20BM is extended, for example, along the outer frame of a display screen of the liquid crystal display device 1 and in the row direction between each picture element 10P.

A spacer may be provided between the first substrate 100 and the second substrate 200. The spacer has a function of securing a gap of space in which the liquid crystal layer 300 is formed. The spacer is in the shape of, for example, a column. The spacer may be placed on at least either the first substrate 100 or the second substrate 200 or may be placed on both of the substrates. The spacer is provided, for example, in the second substrate 200 and does not need to have its tip in contact with the first substrate 100. The spacer may, for example, be polygonal, circular, or elliptical in planar shape. The spacer is, for example, in the shape of a truncated cone, a circular cylinder, a truncated elliptical cone, a truncated pyramid, a prism, or other shapes. Examples of the truncated pyramid include a truncated quadrangular pyramid. Examples of the prism include a quadrangular prism.

It is preferable that the spacer contain, for example, a hardened material of photosensitive resin. Examples of the photosensitive resin include resin having an ultraviolet reactive functional group.

The liquid crystal layer 300 contains a liquid crystal material and is configured such that the amount of light that travels through the liquid crystal layer 300 is controlled by applying a voltage to the liquid crystal layer 300 and changing a state of alignment of the liquid crystal molecules 300L in the liquid crystal material according to the voltage thus applied. The liquid crystal molecules 300L may be ones whose dielectric constant anisotropy (Δε) as defined by Formula L1 below assumes a positive value or a negative value. The liquid crystal molecules 300L of the present embodiment has positive dielectric constant anisotropy. Such an aspect makes it possible to bring about improvement in response speed.

The liquid crystal molecules 300L are called “positive liquid crystals” when having positive dielectric constant anisotropy and called “negative liquid crystals” when having negative dielectric constant anisotropy. A long axis direction of the liquid crystal molecules 300L is an alignment direction (slow axis direction). Further, in the absence of the application of a voltage between the first electrode 100E1 and the second electrode 100E2 (i.e. in the absence of the application of a voltage), the liquid crystal molecules 300L are homogeneously aligned, and the long axis direction of the liquid crystal molecules 300L in the absence of the application of a voltage is also called “initial alignment direction of the liquid crystal molecules 300L”.

Δε=(Dielectric constant of liquid crystal molecules in long axis direction)−(Dielectric constant of liquid crystal molecules in short axis direction) (Formula L1)

The liquid crystal molecules 300L are horizontally aligned in the absence of the application of a voltage. That the liquid crystal molecules 300L are horizontally aligned means that in the absence of the application of a voltage to the liquid crystal layer 300 (i.e. in a case where the voltage applied to the liquid crystal layer 300 is lower than a threshold voltage), the liquid crystal molecules 300L in the liquid crystal layer 300 are aligned substantially parallel to a principal surface of the first substrate 100 and a principal surface of the second substrate 200. That the liquid crystal molecules are aligned substantially parallel to the principal surfaces of the substrates here means that the liquid crystal molecules have a pretilt angle of 0 degree to 5 degrees, preferably 0 degree to 2 degrees, more preferably 0 degree to 1 degrees, with respect to the principal surfaces of the substrates.

The pretilt angle of the liquid crystal molecules means an angle at which the long axes of the liquid crystal molecules are inclined with respect to the principal surfaces of the substrates in the absence of the application of a voltage to the liquid crystal layer. The presence of the application of a voltage between the first electrode 100E1 and the second electrode 100E2 (i.e. between the common electrode and the pixel electrode) is herein simply referred to as the “presence of the application of a voltage”, and the absence of the application of a voltage between the first electrode 100E1 and the second electrode 100E2 (i.e. between the common electrode and the pixel electrode) is herein simply referred to as the “absence of the application of a voltage”.

The liquid crystal display device 1 includes a gate driver connected to the gate lines 120L, a source driver connected to the source lines 150L, and a controller connected to the gate driver and the source driver. The gate driver supplies the gate lines 120L with scanning signals in sequence based on control exercised by the controller. At a timing when the non-linear elements 100T are turned on by the scanning signals, the source driver supplies the source lines 150L with data signals based on control exercised by the controller.

Each of the pixel electrodes is set to a potential corresponding to a data signal supplied via a corresponding one of the non-linear elements 100T, and a fringe field is generated between the common electrode and the pixel electrode, so that the liquid crystal molecules 300L of the liquid crystal layer 300 rotate. By thus changing the retardation of the liquid crystal layer 300 by controlling the magnitude of a voltage that is applied between the common electrode and the pixel electrode, whether to transmit or not to transmit light is controlled. The liquid crystal display device 1 of the present embodiment is an FFS (fringe field switching) mode liquid crystal display device.

The first alignment film 410 and the second alignment film 420, which have a function of controlling the alignment of the liquid crystal molecules 300L contained in the liquid crystal layer 300, are placed between the first substrate 100 and the liquid crystal layer 300 and between the second substrate 200 and the liquid crystal layer 300, respectively. The first alignment film 410 and the second alignment film 420 are horizontal alignment films that have a function of, in the absence of the application of a voltage to the liquid crystal layer 300 (i.e. in a case where the voltage applied to the liquid crystal layer 300 is lower than a threshold voltage), causing the liquid crystal molecules 300L contained in the liquid crystal layer 300 to be aligned substantially parallel to the principal surface of the first substrate 100 and the principal surface of the second substrate 200, respectively.

Examples of an alignment process method for the first alignment film 410 and the second alignment film 420 include a method (degradative photo-alignment method) in which a macromolecular chain of an alignment film in a certain direction is cut by irradiation with polarized light, a method (anisotropic photo-alignment method) in which a photosensitive group in an alignment film is brought into a cis-trans isomerization reaction by irradiation with polarized light, and a method (rubbing alignment method) in which a macromolecular chain on a surface of an alignment film is aligned in a certain direction by rubbing the surface with raised fabric.

It is preferable that the first alignment film 410 of the present embodiment be subjected to an alignment process by the degradative photo-alignment method. The degradative photo-alignment method is susceptible to a step and prone to cause a decrease in display contrast but can effectively improve the display contrast of the liquid crystal display device 1 of the present embodiment.

A usable example of the first alignment film 410 is a photodegradable polyimide alignment film of RB Series manufactured by Nissan Chemical Corporation.

### Embodiment 2

The present embodiment primarily describes features peculiar to the present embodiment and omits a description of contents that overlap those of Embodiment 1 described above. The present embodiment is substantially the same as Embodiment 1 except that the dielectric constant anisotropy of the liquid crystal molecules 300L is different. While the liquid crystal molecules 300L of the liquid crystal display device 1 of Embodiment 1 described above have positive dielectric constant anisotropy, the liquid crystal molecules 300L of the present embodiment have negative dielectric constant anisotropy. Such an aspect makes it possible to improve the display contrast. Further, such an aspect also makes it possible to bring about improvement in transmittance.

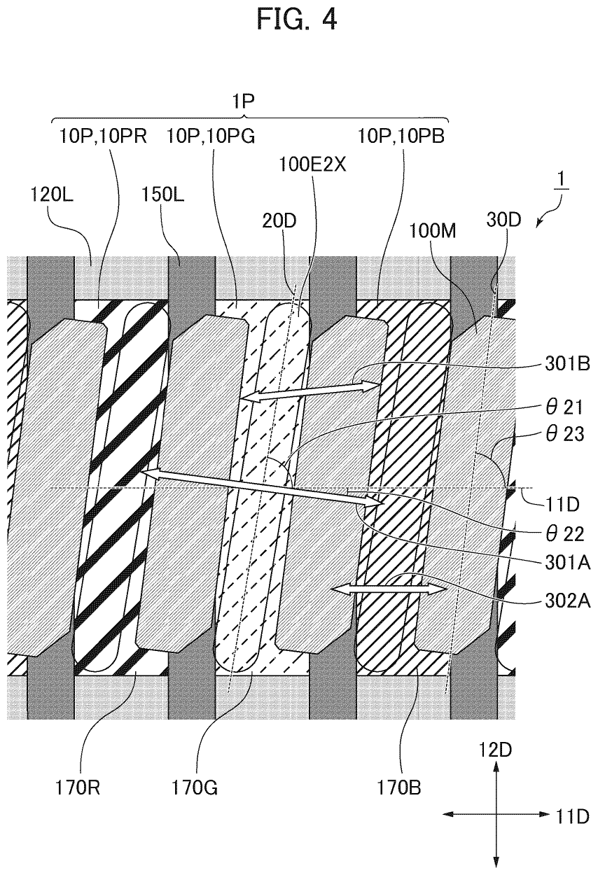

FIG. 4 is a plan schematic view of a liquid crystal display device according to Embodiment 2. As shown in FIG. 4, in a plan view, a longitudinal direction 20D of the opening 100E2X is inclined at an angle θ21 [degrees] in one direction that is either clockwise or counterclockwise (in the present embodiment, counterclockwise) with respect to the first direction 11D, and in a plan view, an alignment direction 301A of the liquid crystal molecules 300L located near the first substrate 100 and in a central part of the opening 100E2X, in a state where no voltage is applied, is inclined at an angle θ22 [degrees] in a direction (in the present embodiment, clockwise) opposite to the one direction with respect to the first direction 11D. Such an aspect makes it possible to improve the display contrast.

The liquid crystal display device 1 may satisfy Formula 2-1 as below. Such an aspect makes it possible to further improve the display contrast.

θ22<90°−θ21 (Formula 2-1)

It is preferable that the angle θ22 [degrees] be smaller than an angle (90°−θ21).

It is preferable that the angle θ22 [degrees] be 0.01 or more times and 0.5 or less times as large as the angle (90°−θ21), more preferably 0.01 or more times and 0.2 or less times as large as the angle (90°−θ21), even more preferably 0.05 or more times and 0.2 or less times as large as the angle (90°−θ21).

The liquid crystal display device 1 may satisfy Formula 2-2 as below. Such an aspect makes it possible to further improve the display contrast.

45°<θ21<90° (Formula 2-2)

It is preferable that the angle θ21 [degrees] be 45 degrees or larger and 89 degrees or smaller, more preferably 75 degrees or larger and 85 degrees or smaller. Such an aspect makes it possible to achieve a high-definition and high-drive-frequency liquid crystal display device 1.

It is preferable that the angle θ22 [degrees] be 0.2 degree or larger and 5 degrees or smaller, more preferably 0.5 degree or larger and 3 degrees or smaller, even more preferably 0.5 degree or larger and 2 degrees or smaller.

In a plan view, an alignment direction 302A in the absence of the application of a voltage of those of the liquid crystal molecules 300L located near the second substrate 200 and in the central part of the opening 100E2X may be parallel to the first direction 11D. Such an aspect makes it possible to further improve the display contrast. That the alignment direction is parallel to the first direction here means that the alignment direction and the first direction form an angle of 0 degree or larger and 0.5 degree or smaller.

When, in a plan view, a longitudinal direction 30D of the light-shielding film 100M is inclined at an angle θ23 [degrees] in the one direction (in the present embodiment, counterclockwise) with respect to the first direction 11D, it is preferable that the liquid crystal display device 1 satisfy Formula (2-3) as below. Such an aspect makes it possible to avoid interference between the light-shielding film 100M and the opening 100E2X of the second electrode 100E2, making it possible to improve display performance.

90°−θ23≤90°−θ21 Formula 2-3

It is preferable that the angle (90°−θ23) be 0 or more times and 1 or less times as large as the angle (90°−θ21), more preferably 0 or more times and 0.85 or less times as large as the angle (90°−θ21), even more preferably 0 or more times and 0.7 or less times as large as the angle (90°−θ21).

It is preferable that the angle θ23 [degrees] be 75 degrees or larger and 90 degrees or smaller, more preferably 77.25 degrees or larger and 90 degrees or smaller, even more preferably 79.5 degrees or larger and 90 degrees or smaller.

### Modification of Embodiments 1 and 2

Although, in Embodiments 1 and 2, the second direction 12D is orthogonal to the first direction 11D, which corresponds to the row direction, the second direction 12D may not be orthogonal to the first direction 11D (i.e. may be inclined with respect to the column direction.

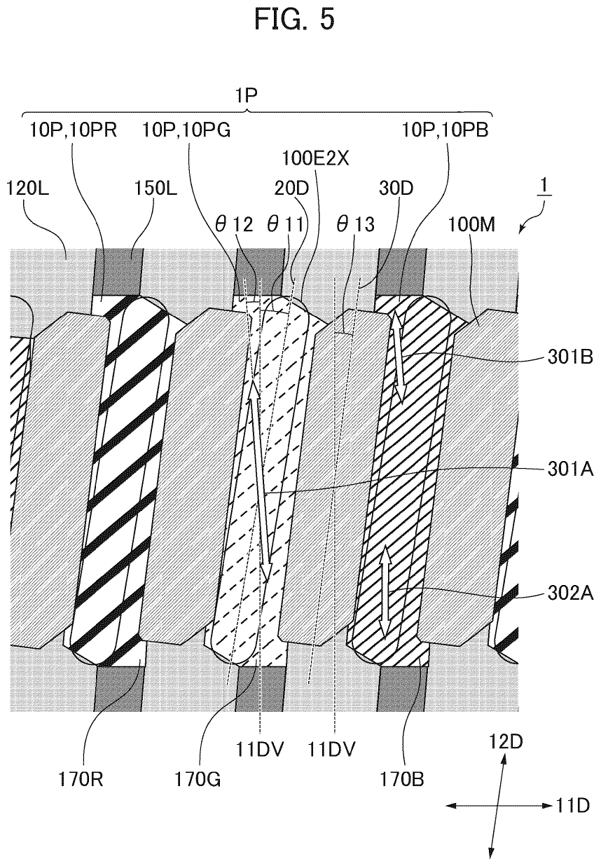

FIG. 5 is a plan schematic view of a liquid crystal display device according to a modification of Embodiments 1 and 2. As shown in FIG. 5, the second direction 12D of the present modification is inclined with respect to the column direction (in the drawing, an up-down direction). As in the case of Embodiments 1 and 2, the first direction 11D of the present modification corresponds to the row direction. It is preferable that the first direction 11D and the second direction 12D form an angle of 70 degrees or larger and 95 degrees or smaller, more preferably 75 degrees or larger and 92 degrees or smaller, or even more preferably 80 degrees or larger and 90 degrees or smaller. Such an aspect makes it possible to improve the aperture ratio of the picture elements 10P.

In the present modification, the source lines 150L are in zigzag shapes having bends near the gate electrodes in order that the openings 100E2X are inclined in a uniform direction. When attention is paid to part of each of the source lines 150L of the present modification, the source line 150L is extended in a direction inclined with respect to the column direction as shown in FIG. 5; however, as a whole, the source line 150L extends along the column direction. That is, a direction from one end of the source line 150L to the other is along the column direction.

Since the thickness of each of the source electrodes (source lines 150L) is, for example, 350 nm or greater and 550 nm or less, a step of the source electrode remains influential even when the color filter layer 170 and the planarizing film 180 are formed. However, the configuration of the present modification makes it possible to improve the display contrast.

The following describes effects of the present disclosure with reference to examples, comparative examples, and reference examples; however, the present disclosure is not limited by these examples.

### Example 1

A liquid crystal display device of Example 1 corresponding to the liquid crystal display device 1 according to Embodiment 1 was fabricated. The liquid crystal display device of the present example had a resolution of 1400 ppi. Each pixel 1P had a size of 18 μm per side, and each picture element 10P had a size of 6 μm×18 μm.

Gate lines 120L were formed on top of a first support substrate 110. Next, a gate insulating layer (first insulating layer 130) and thin-film transistors (non-linear elements 100T) were formed. Furthermore, source lines 150L were formed. The source lines 150L also functioned as a light-shielding film between the picture elements 10P.

Next, over the source lines 150L, a color filter layer 170 having color filters of multiple colors (red color filters 170R, blue color filters 170B, and green color filters 170G) was formed using colored organic resists. Two of the color filters of multiple colors that were adjacent to each other in the row direction were continuously formed substantially flush with each other near the center of a source line 150L in the width direction. Color filters of each color were continuously formed across the gate lines 120L in the column direction. A planarizing film 180 was provided on a side of the color filter layer 170 that faced a liquid crystal layer 300. The planarizing film 180 was an organic planarizing film. Flatness was successfully secured by forming the planarizing film 180 on top of the color filter layer 170.

Next, through-holes (contact holes) 10CH1 for electrically connecting pixel electrodes (first electrodes 100E1) and drain electrodes 150D of the thin-film transistors were bored through the color filter layer 170 and the planarizing film 180.

For performing a display in an FFS mode, the first electrodes 100E1 (pixel electrodes), an insulating layer 100F, a second electrode 100E2 (common electrode) were formed over the through-holes. Next, a light-shielding film 100M was formed, whereby a first substrate 100 was fabricated. Furthermore, a first alignment film 410 was formed on top of the light-shielding film 100M.

In the second electrode 100E2, a slit (opening 100E2X) inclined at 15 degrees clockwise with respect to a direction perpendicular to the panel outer shape (specifically, a direction 11DV perpendicular to the first direction 11D; in the drawing, a lengthwise direction) was provided. Further, in order to suppress interference with the slit, the light-shielding film 100M was formed such that a principal side (longitudinal direction) of the light-shielding film 100M was inclined at 10 degrees in the same direction (i.e. clockwise with respect to the direction 11DV perpendicular to the first direction 11D). That is, the angle θ11 [degrees] was 15 degrees, and the angle θ13 [degrees] was 10 degrees.

The first alignment film 410 used was a photodegradable alignment film that causes liquid crystal molecules 300L to be aligned in a direction perpendicular to transmitted polarized light by irradiation with polarized ultraviolet radiation, and an alignment process was performed on the first alignment film 410 so that in a plan view, an alignment direction 301A in the absence of the application of a voltage of those of the liquid crystal molecules 300L located near the first substrate 100 and in a central part of the opening 100E2X was inclined at 1.5 degrees counterclockwise with respect to the direction 11DV perpendicular to the first direction 11D. That is, the angle θ12 [degrees] was 1.5 degrees.

Next, a second substrate 200 was fabricated by forming, on a second support substrate 210, a second substrate side light-shielding film 20BM extending in a gate line extension direction (first direction 11D) between the outer frame of a display screen and each picture element 10P. Furthermore, a second alignment film 420 was formed on the second substrate side light-shielding film 20BM, and an alignment process was performed on the second alignment film 420 so that in a plan view, an alignment direction 302A in the absence of the application of a voltage of those of the liquid crystal molecules 300L located near the second substrate 200 and in the central part of the opening 100E2X became orthogonal to the first direction 11D. In a plan view, the alignment direction 302A in the absence of the application of a voltage of those of the liquid crystal molecules 300L located near the second substrate 200 and in the central part of the opening 100E2X and the first direction 11D formed an angle of 89.5 degrees or larger and 90 degrees or smaller.

The first substrate 100 provided with the first alignment film 410 and the second substrate 200 provided with the second alignment film 420 were placed opposite each other so that the two alignment films faced each other, and were bonded together with the liquid crystal layer 300 sandwiched between the two alignment films. The liquid crystal molecules 300L contained in the liquid crystal layer 300 had positive dielectric constant anisotropy.

Furthermore, a first polarizing plate 510 was placed on a side of the first substrate 100 that faced away from the liquid crystal layer 300, and a second polarizing plate 520 was placed on a side of the second substrate 200 that faced away from the liquid crystal layer 300, whereby a liquid crystal panel was obtained. A polarizing axis of the first polarizing plate 510 was parallel to the first direction 11D, and the polarizing axis of the first polarizing plate 510 and a polarizing axis of the second polarizing plate 520 were orthogonal to each other.

Furthermore, drivers (a source driver and a gate driver) and a driving circuit were connected to the liquid crystal panel; furthermore, a backlight was placed, whereby a liquid crystal display device was fabricated.

Observation of the liquid crystal display device of the present example by an optical microscope showed that as shown in FIG. 1, in a plan view, an alignment direction 301B of those of the liquid crystal molecules 300L near a step located near the first substrate 100 and at an end of the opening 100E2X (i.e. located in an area where a misalignment tends to occur) was inclined at 2 degrees to 4 degrees clockwise with respect to the direction 11DV perpendicular to the first direction 11D. Further, the display contrast of the liquid crystal display device 1 was 650.

### Comparative Example 1

As Comparative Example 1, a conventional FFS mode liquid crystal display device shown in FIG. 3 was fabricated. The display contrast of the liquid crystal display device of Comparative Example 1 was 550.

### Evaluations of Example 1 and Comparative Example 1

As a result of performing an alignment process on the first alignment film so that the alignment direction of the liquid crystal molecules in the absence of the application of a voltage became orthogonal to the first direction, the display contrast of the liquid crystal display device of Comparative Example 1 was 550. On the other hand, in the present example, the display contrast was successfully improved to 650 by performing an alignment process on the first alignment film 410 so that in a plan view, the alignment direction 301A in the absence of the application of a voltage of those of the liquid crystal molecules 300L located near the first substrate 100 and in the central part of the opening 100E2X formed an angle of 1.5 degrees counterclockwise with respect to the direction 11DV perpendicular to the first direction 11D.

### Example 2

A liquid crystal display device of Example 2 corresponding to the liquid crystal display device 1 according to the modification of Embodiment 1 was fabricated. The liquid crystal display device of Example 2 was fabricated in the same manner as that of Example 1 except that the source lines 150L were formed in zigzag shapes. That is, the angle θ11 [degrees] was 15 degrees, the angle θ12 [degrees] was 1.5 degrees, and the angle θ13 [degrees] was 10 degrees. Further, in a plan view, the alignment direction 302A in the absence of the application of a voltage of those of the liquid crystal molecules 300L located near the second substrate 200 and in the central part of the opening 100E2X and the first direction 11D formed an angle of 89.5 degrees or larger and 90 degrees or smaller.

Observation of the liquid crystal display device of the present example by an optical microscope showed that as shown in FIG. 5, in a plan view, an alignment direction 301B of those of the liquid crystal molecules 300L near a step located near the first substrate 100 and at an end of the opening 100E2X (i.e. located in an area where a misalignment tends to occur) was inclined at 2.5 degrees to 4.5 degrees clockwise with respect to the direction 11DV perpendicular to the first direction 11D. Further, the display contrast was 600.

### Comparative Example 2

As Comparative Example 2, a liquid crystal display device of Comparative Example 2 that is the same the conventional FFS mode shown in FIG. 3 except that the source lines 150L were formed in zigzag shapes was fabricated. The display contrast of the liquid crystal display device of Comparative Example 2 was 500.

### Evaluations of Example 2 and Comparative Example 2

As a result of performing an alignment process on the first alignment film so that the alignment direction of the liquid crystal molecules in the absence of the application of a voltage became orthogonal to the first direction, the display contrast of the liquid crystal display device of Comparative Example 2 was 500. On the other hand, in the present example, the display contrast was successfully improved to 600 by performing an alignment process on the first alignment film 410 so that in a plan view, the alignment direction 301A in the absence of the application of a voltage of those of the liquid crystal molecules 300L located near the first substrate 100 and in the central part of the opening 100E2X formed an angle of 1.5 degrees counterclockwise with respect to the direction 11DV perpendicular to the first direction 11D.

### Examples 3 and 4

A liquid crystal display device of Example 3 corresponding the liquid crystal display device 1 according to Embodiment 2 and a liquid crystal display device of Example 4 corresponding the liquid crystal display device 1 according to the modification of Embodiment 2 were fabricated.

Specifically, the liquid crystal display devices of Examples 3 and 4 were fabricated in the same manner as those of Examples 1 and 2, respectively, except that the liquid crystal molecules 300L used had negative dielectric constant anisotropy. Since the shapes of the openings 100E2X of Examples 3 and 4 are the same as those of Examples 1 and 2, respectively, the alignment directions of the liquid crystal molecules 300L of Examples 3 and 4, which had negative dielectric constant anisotropy, differed by 90 degrees from the liquid crystal molecules 300L of Examples 1 and 2, which had positive dielectric constant anisotropy, respectively. Further, in a plan view, deviations in alignment direction of the liquid crystal molecules 300L located at the ends of the openings 100E2X of Examples 3 and 4 (i.e. located in areas where misalignments tend to occur) were opposite to those of Examples 1 and 2, respectively.

The slit (opening 100E2X) provided in the second electrode 100E2 of each of Examples 3 and 4 was inclined at 75 degrees counterclockwise with respect to a direction horizontal to the panel outer shape (specifically, the first direction 11D; in the drawing, a crosswise direction). Further, a principal side (longitudinal direction) of the light-shielding film 100M of each of Examples 3 and 4 was inclined at 80 degrees in the same direction (i.e. counterclockwise with respect to the first direction 11D). That is, the angle θ21 [degrees] was 75 degrees, and the angle θ23 [degrees] was 80 degrees.

In each of Examples 3 and 4, an alignment process was performed on the first alignment film 410 so that in a plan view, an alignment direction 301A in the absence of the application of a voltage of those of the liquid crystal molecules 300L located near the first substrate 100 and in a central part of the opening 100E2X was inclined at 1.5 degrees clockwise with respect to a direction (first direction 11D) horizontal to the panel outer shape. That is, the angle θ22 [degrees] was 1.5 degrees.

Further, in each of Examples 3 and 4, an alignment process was performed on the second alignment film 420 so that in a plan view, the alignment direction 302A in the absence of the application of a voltage of those of the liquid crystal molecules 300L located near the second substrate 200 and in the central part of the opening 100E2X became parallel to the first direction 11D. In a plan view, the alignment direction 302A in the absence of the application of a voltage of those of the liquid crystal molecules 300L located near the second substrate 200 and in the central part of the opening 100E2X and the first direction 11D formed an angle of 0 degree or larger and 0.5 degree or smaller.

Observation of the liquid crystal display device of Example 3 by an optical microscope showed that as shown in FIG. 4, in a plan view, an alignment direction 301B of those of the liquid crystal molecules 300L near a step located near the first substrate 100 and at an end of the opening 100E2X (i.e. located in an area where a misalignment tends to occur) was inclined at 2 degrees to 4 degrees counterclockwise with respect to the first direction 11D. Further, since the liquid crystal molecules 300L used had negative dielectric constant anisotropy, white luminance improved over Example 1; therefore, the display contrast improved by about 50 over Example 1.

Observation of the liquid crystal display device of Example 4 by an optical microscope showed that, in a plan view, an alignment direction 301B of those of the liquid crystal molecules 300L near a step located near the first substrate 100 and at an end of the opening 100E2X (i.e. located in an area where a misalignment tends to occur) was inclined at 2.5 degrees to 4.5 degrees counterclockwise with respect to the first direction 11D. Further, since the liquid crystal molecules 300L used had negative dielectric constant anisotropy, white luminance improved over Example 2; therefore, the display contrast improved by about 50 over Example 2.

The foregoing has described embodiments of the present disclosure and a modification thereof; however, the present disclosure is not limited to the embodiments and the modification thereof but can be carried out in various aspects and modifications thereof without departing from the scope of the present disclosure. Further, a plurality of constituent elements disclosed in the embodiments and the modification thereof can be altered as appropriate. For example, one of all constituent elements shown in an embodiment or modification may be added as a constituent element of another embodiment or modification, or some of all constituent elements shown in an embodiment or modification may be deleted from the embodiment or modification.

Further, the drawings mostly schematically show each constituent element to facilitate understanding of the disclosure, and the thickness, length, number, interval, or other attributes of each constituent element may be different from actual ones for the convenience of preparation of the drawings. Further, a configuration of each constituent element shown in the foregoing embodiments is merely an example and is not limited in particular, and various changes can be made without substantially departing from the effects of the present disclosure.

Embodiments of the present disclosure provide solutions described in the following items.

### [Item 1]

A liquid crystal display device having a plurality of picture elements arranged in a matrix, the liquid crystal display device comprising:
a first substrate including a plurality of gate lines extended in a first direction, a plurality of source lines extended in a second direction intersecting the first direction, and a non-linear element placed in correspondence with a point of intersection of each gate line and each source line;
a second substrate placed opposite the first substrate; and
a liquid crystal layer, sandwiched between the first substrate and the second substrate, that contains liquid crystal molecules having positive dielectric constant anisotropy,
wherein
each picture element is defined by two gate lines that are adjacent to each other and two source lines that are adjacent to each other,
the first substrate further includes, in sequence, a first electrode, an insulating layer, and a second electrode having a long-shaped opening provided therein,
in a plan view, a longitudinal direction of the opening is inclined at an angle θ11 [degrees] in one direction that is either clockwise or counterclockwise with respect to a direction perpendicular to the first direction, and
in a plan view, an alignment direction of the liquid crystal molecules located near the first substrate and in a central part of the opening, in a state where no voltage is applied, is inclined at an angle θ12 [degrees] in a direction opposite to the one direction with respect to the direction perpendicular to the first direction.

### [Item 2]

The liquid crystal display device according to Item 1, wherein θ12<θ11 (Formula 1-1).

### [Item 3]

The liquid crystal display device according to Item 1 or 2, wherein 0°<θ11<45° (Formula 1-2).

### [Item 4]

The liquid crystal display device according to any one of Items 1 to 3, in a plan view, an alignment direction of the liquid crystal molecules located near the second substrate and in the central part of the opening, in a state where no voltage is applied, is orthogonal to the first direction.

### [Item 5]

The liquid crystal display device according to any one of Items 1 to 4, wherein the first substrate further includes a color filter layer.

### [Item 6]

The liquid crystal display device according to any one of Items 1 to 5, wherein
a plurality of the openings is provided, and
the plurality of openings is placed one by one in each picture element.

### [Item 7]

The liquid crystal display device according to any one of Items 1 to 6, further comprising a metal-containing light-shielding film between the plurality of picture elements in a plan view.

### [Item 8]

The liquid crystal display device according to Item 7, wherein the light-shielding film is in an island shape in a plan view.

### [Item 9]

The liquid crystal display device according to any one of Items 1 to 8, wherein the liquid crystal display device has a resolution of 1200 ppi or higher.

### [Item 10]

A liquid crystal display device having a plurality of picture elements arranged in a matrix, the liquid crystal display device comprising:
a first substrate including a plurality of gate lines extended in a first direction, a plurality of source lines extended in a second direction intersecting the first direction, and a non-linear element placed in correspondence with a point of intersection of each gate line and each source line;
a second substrate placed opposite the first substrate; and
a liquid crystal layer, sandwiched between the first substrate and the second substrate, that contains liquid crystal molecules having negative dielectric constant anisotropy,
wherein
each picture element is defined by two gate lines that are adjacent to each other and two source lines that are adjacent to each other,
the first substrate further includes, in sequence, a first electrode, an insulating layer, and a second electrode having a long-shaped opening provided therein,
in a plan view, a longitudinal direction of the opening is inclined at an angle θ21 [degrees] in one direction that is either clockwise or counterclockwise with respect to the first direction, and
in a plan view, an alignment direction of the liquid crystal molecules located near the first substrate and in a central part of the opening, in a state where no voltage is applied, is inclined at an angle θ22 [degrees] in a direction opposite to the one direction with respect to the first direction.

### [Item 11]

The liquid crystal display device according to Item 10, wherein θ22<90°−θ21 (Formula 2-1).

### [Item 12]

The liquid crystal display device according to Item 10 or 11, wherein 45°<θ21<90° (Formula 2-2).

### [Item 13]

The liquid crystal display device according to any one of Items 10 to 12, in a plan view, an alignment direction of the liquid crystal molecules located near the second substrate and in the central part of the opening, in a state where no voltage is applied, is parallel to the first direction.

### [Item 14]

The liquid crystal display device according to any one of Items 10 to 13, wherein the first substrate further includes a color filter layer.

### [Item 15]

The liquid crystal display device according to any one of Items 10 to 14, wherein
a plurality of the openings is provided, and
the plurality of openings is placed one by one in each picture element.

### [Item 16]

The liquid crystal display device according to any one of Items 10 to 15, further comprising a metal-containing light-shielding film between the plurality of picture elements in a plan view.

### [Item 17]

The liquid crystal display device according to Item 16, wherein the light-shielding film is in an island shape in a plan view.

### [Item 18]

The liquid crystal display device according to any one of Items 10 to 17, wherein the liquid crystal display device has a resolution of 1200 ppi or higher.

### [Item 19]

The liquid crystal display device according to any one of Items 1 to 18, further comprising:
a first polarizing plate, placed on a side of the first substrate that faces away from the liquid crystal layer, that has a first polarizing axis parallel or orthogonal to the first direction; and
a second polarizing plate, placed on a side of the second substrate that faces away from the liquid crystal layer, that has a second polarizing axis orthogonal to the first polarizing axis.

The present disclosure contains subject matter related to that disclosed in Japanese Priority Patent Application JP 2024-109608 filed in the Japan Patent Office on Jul. 8, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device having a plurality of picture elements arranged in a matrix, the liquid crystal display device comprising:
a first substrate including a plurality of gate lines extended in a first direction, a plurality of source lines extended in a second direction intersecting the first direction, and a non-linear element placed in correspondence with a point of intersection of each gate line and each source line;
a second substrate placed opposite the first substrate; and
a liquid crystal layer, sandwiched between the first substrate and the second substrate, that contains liquid crystal molecules having positive dielectric constant anisotropy,
wherein
each picture element is defined by two gate lines that are adjacent to each other and two source lines that are adjacent to each other,
the first substrate further includes, in sequence, a first electrode, an insulating layer, and a second electrode having a long-shaped opening provided therein,
in a plan view, a longitudinal direction of the opening is inclined at an angle θ11 [degrees] in one direction that is either clockwise or counterclockwise with respect to a direction perpendicular to the first direction, and
in a plan view, an alignment direction of the liquid crystal molecules located near the first substrate and in a central part of the opening, in a state where no voltage is applied, is inclined at an angle θ12 [degrees] in a direction opposite to the one direction with respect to the direction perpendicular to the first direction.

2. The liquid crystal display device according to claim 1, wherein θ12<θ11 (Formula 1-1).

3. The liquid crystal display device according to claim 1, wherein 0°<θ11<45° (Formula 1-2).

4. The liquid crystal display device according to claim 1, in a plan view, an alignment direction of the liquid crystal molecules located near the second substrate and in the central part of the opening, in a state where no voltage is applied, is orthogonal to the first direction.

5. The liquid crystal display device according to claim 1, wherein the first substrate further includes a color filter layer.

6. The liquid crystal display device according to claim 1, wherein
a plurality of the openings is provided, and
the plurality of openings is placed one by one in each picture element.

7. The liquid crystal display device according to claim 1, further comprising a metal-containing light-shielding film between the plurality of picture elements in a plan view.

8. The liquid crystal display device according to claim 7, wherein the light-shielding film is in an island shape in a plan view.

9. The liquid crystal display device according to claim 1, wherein the liquid crystal display device has a resolution of 1200 ppi or higher.

10. A liquid crystal display device having a plurality of picture elements arranged in a matrix, the liquid crystal display device comprising:
a first substrate including a plurality of gate lines extended in a first direction, a plurality of source lines extended in a second direction intersecting the first direction, and a non-linear element placed in correspondence with a point of intersection of each gate line and each source line;
a second substrate placed opposite the first substrate; and
a liquid crystal layer, sandwiched between the first substrate and the second substrate, that contains liquid crystal molecules having negative dielectric constant anisotropy,
wherein
each picture element is defined by two gate lines that are adjacent to each other and two source lines that are adjacent to each other,
the first substrate further includes, in sequence, a first electrode, an insulating layer, and a second electrode having a long-shaped opening provided therein,
in a plan view, a longitudinal direction of the opening is inclined at an angle θ21 [degrees] in one direction that is either clockwise or counterclockwise with respect to the first direction, and
in a plan view, an alignment direction of the liquid crystal molecules located near the first substrate and in a central part of the opening, in a state where no voltage is applied, is inclined at an angle θ22 [degrees] in a direction opposite to the one direction with respect to the first direction.

11. The liquid crystal display device according to claim 10, wherein θ22<90°−θ21 (Formula 2-1).

12. The liquid crystal display device according to claim 10, wherein 45°<θ21<90° (Formula 2-2).

13. The liquid crystal display device according to claim 10, in a plan view, an alignment direction of the liquid crystal molecules located near the second substrate and in the central part of the opening, in a state where no voltage is applied, is parallel to the first direction.

14. The liquid crystal display device according to claim 10, wherein the first substrate further includes a color filter layer.

15. The liquid crystal display device according to claim 10, wherein
a plurality of the openings is provided, and
the plurality of openings is placed one by one in each picture element.

16. The liquid crystal display device according to claim 10, further comprising a metal-containing light-shielding film between the plurality of picture elements in a plan view.

17. The liquid crystal display device according to claim 16, wherein the light-shielding film is in an island shape in a plan view.

18. The liquid crystal display device according to claim 10, wherein the liquid crystal display device has a resolution of 1200 ppi or higher.

19. The liquid crystal display device according to claim 1, further comprising:
a first polarizing plate, placed on a side of the first substrate that faces away from the liquid crystal layer, that has a first polarizing axis parallel or orthogonal to the first direction; and
a second polarizing plate, placed on a side of the second substrate that faces away from the liquid crystal layer, that has a second polarizing axis orthogonal to the first polarizing axis.

20. The liquid crystal display device according to claim 10, further comprising:
a first polarizing plate, placed on a side of the first substrate that faces away from the liquid crystal layer, that has a first polarizing axis parallel or orthogonal to the first direction; and
a second polarizing plate, placed on a side of the second substrate that faces away from the liquid crystal layer, that has a second polarizing axis orthogonal to the first polarizing axis.
